(19) United States
(12) Patent Application Publication
(10) Pub. No.: US 2026/0246129 A1
(43) Pub. Date: Aug. 20, 2026

(54) FILTER, ANTENNA APPARATUS, AND COMMUNICATION DEVICE

(71) Applicant: HUAWEI TECHNOLOGIES CO., LTD., Shenzhen (CN)

(72) Inventors: Ruinian Huang, Dongguan (CN); Xinyong Lu, Dongguan (CN); Guoshuai Zhao, Dongguan (CN); Damiao Wu, Shenzhen (CN); Yinjian He, Dongguan (CN); Jinliang He, Dongguan (CN)

(73) Assignee: HUAWEI TECHNOLOGIES CO., LTD., Shenzhen (CN)

(21) Appl. No.: 19/646,238

(22) Filed: Apr. 13, 2026

Related U.S. Application Data
(63) Continuation of application No. PCT/CN2024/116618, filed on Sep. 3, 2024.

(30) Foreign Application Priority Data
Oct. 13, 2023 (CN) 202311332155.0

(51) Int. Cl. H01P 1/207; H01P 7/06; H04B 1/00

(52) U.S. Cl. CPC H01P 1/207; H01P 7/06; H04B 1/0064

(57) ABSTRACT

Embodiments of this application provide a filter, an antenna apparatus, and a communication device, and relate to the field of communication technologies,. In the filter, a second resonant body is stacked with a first resonant body, and the second resonant body is decoupled from the first resonant body. A first connector penetrates the second resonant body, the first connector is decoupled from the second resonant body, a first end of the first connector is coupled to the first resonant body, and a second end of the first connector extends out of the second resonant body. In addition, a first end of a second connector is coupled to the second resonant body, and the second connector and the first connector are disposed on a same side of the first resonant body.

### CROSS-REFERENCE TO RELATED APPLICATIONS

This application is a continuation of International Application No. PCT/CN2024/116618, filed on September 3, 2024, which claims priority to Chinese Patent Application No. 202311332155.0, filed on October 13, 2023. The disclosures of the aforementioned applications are hereby incorporated by reference in their entireties.

### TECHNICAL FIELD

This application relates to the field of communication technologies, and in particular, to a filter, an antenna apparatus, and a communication device.

### BACKGROUND

Communication devices typically adopt wireless communication technologies, for example, multiple-input multiple-output (multiple input multiple output, MIMO). The MIMO technology can exploit spatial multiplexing (spatial multiplexing) to dispose a plurality of transmitter (transmitter, TX) antennas (antennas, ANTs) at a transmit end, and dispose a plurality of receiver (receiver, RX) antennas at a receive end, so as to increase a quantity of signal transceiver channels, thereby transmitting more data, increasing system capacities, and increasing frequency coverage. Based on this, as a quantity of channels continuously increases, to accommodate more signal transceiver channels, there is a need to increase a quantity of filters (filters) in the communication device. However, an increase in a size of the filter in return causes an increase in a board layout area inside the communication device. Consequently, a structural size of the communication device is increased, and this is not conducive to product miniaturization.

### SUMMARY

This application provides a filter, an antenna apparatus, and a communication device, to alleviate a problem of large board layout area occupation by the filter, which leads to increased dimensions of the communication device.

To achieve the foregoing objective, this application uses the following technical solutions.

According to an aspect of this application, a filter is provided. The filter includes a first resonant body, a second resonant body, at least one first connector, and at least one second connector. The second resonant body is stacked with the first resonant body, and the second resonant body is decoupled from the first resonant body. The first connector penetrates the second resonant body, the first connector is decoupled from the second resonant body, a first end of the first connector is coupled to the first resonant body, and a second end of the first connector extends out of the second resonant body. In addition, a first end of a second connector is coupled to the second resonant body, and the second connector and the first connector are disposed on a same side of the first resonant body.

In conclusion, the filter provided in this embodiment of this application may include the first resonant body and the second resonant body that are stacked, the first connector coupled to the first resonant body, and the second connector coupled to the second resonant body. In addition, the first resonant body is decoupled from the second resonant body, and the first connector coupled to the first resonant body is decoupled from the second resonant body. In this way, because the first resonant body and the second resonant body are stacked, the first connector coupled to the first resonant body can penetrate the second resonant body, and the first connector and the second connector are disposed on a same side of the first resonant body. In this case, stacking the first resonant body and the second resonant body in a thickness direction of the filter can reduce a board layout area occupied by the filter, to alleviate a problem that the antenna apparatus with the filter and the communication device have a large size.

In addition, the first resonant body and the second resonant body are independent of each other, and an electrical signal transmitted on the first resonant body and an electrical signal transmitted on the second resonant body do not affect each other. Based on this, when the first connector sends or receives an electrical signal on the first resonant body, and the second connector sends or receives an electrical signal on the second resonant body, a frequency of the electrical signal on the first resonant body may be the same as or different from a frequency of the electrical signal on the second resonant body. The first resonant body and the second resonant body may respectively have independent signal transceiver channels for transmitting the electrical signals, so that a quantity of signal transceiver channels can be effectively increased.

In an optional implementation, the at least one first connector includes a first receiving connector and a first sending connector. The first sending connector and the first receiving connector are located on a same side of the first resonant body. In addition, the at least one second connector includes a second receiving connector and a second sending connector. The second receiving connector and the first receiving connector are disposed on a same side of the first resonant body, and the second sending connector and the first sending connector are disposed on a same side of the first resonant body. In this way, the first receiving connector may be coupled to an antenna board in the antenna apparatus, so as to transmit an electrical signal from the antenna board to the first resonant body through the first receiving connector. The first sending connector may be coupled to the circuit board in the antenna apparatus, so as to transmit the electrical signal from the first resonant body to the circuit board through the first sending connector. Alternatively, the first receiving connector may be coupled to the circuit board, so as to transmit an electrical signal from the circuit board to the first resonant body through the first receiving connector. The first sending connector may be coupled to the antenna board, so as to transmit the electrical signal from the first resonant body to the antenna board through the first sending connector for signal transmission. Technical effects of the second receiving connector and the second sending connector are the same as those described above, and details are not described herein again.

In an optional implementation, the filter further includes a first antenna connector and a second antenna connector. A first end of the first antenna connector is coupled to the first resonant body, and the first antenna connector and the first receiving connector are respectively located on two opposite sides of the first resonant body. The second antenna connector penetrates the first resonant body and is decoupled from the first resonant body. A first end of the second antenna connector is coupled to the second resonant body, and the second antenna connector and the second receiving connector are respectively located on two opposite sides of the second resonant body. In this way, a second end of the first antenna connector may be coupled to the antenna board, to transmit an electrical signal from the antenna board to the first resonant body through the first antenna connector. The first resonant body may filter the electrical signal from the antenna board, or transmit a signal obtained after the first resonant body performs filtering to the antenna board through the first antenna connector for sending. In this case, the first receiving connector may be coupled to a receiving circuit in the circuit board, to transmit an electrical signal obtained after the first resonant body performs filtering to the receiving circuit in the circuit board through the first receiving connector for signal processing. In addition, the first sending connector may be coupled to a sending circuit in the circuit board, to transmit the electrical signal from the circuit board to the first resonant body for filtering, and then to the antenna board through the first antenna connector for sending. In this way, the first resonant body may filter the electrical signal received by the antenna board, and may also filter an electrical signal to be sent by the antenna board. Therefore, the first resonant body may be the foregoing duplexer. Technical effects of the second antenna connector and the second resonant body are the same as those described above, and details are not described herein again.

In an optional implementation, the filter further includes a first antenna connector and a second antenna connector. The first antenna connector penetrates the second resonant body, and the first antenna connector is decoupled from the second resonant body. A first end of the first antenna connector is coupled to the first resonant body, and the first antenna connector and the first receiving connector are located on a same side of the first resonant body. A first end of the second antenna connector is coupled to the second resonant body, and the second antenna connector and the second receiving connector are located on a same side of the second resonant body. In this way, based on a position of the filter in the antenna apparatus, the first antenna connector and the first receiving connector may be disposed on a same side of the first resonant body, and the second antenna connector and the second receiving connector may be disposed on a same side of the second resonant body. In addition, technical effects of the first antenna connector and the second antenna connector are the same as those described above, and details are not described herein again.

In an optional implementation, at least one first resonant cavity and at least one second resonant cavity are disposed on the first resonant body, and the at least one first resonant cavity forms a first signal receiving channel. The at least one second resonant cavity forms a first signal sending channel, and a band-pass frequency of the first signal receiving channel and a band-pass frequency of the first signal sending channel are a first frequency. The first antenna connector is coupled to the first signal receiving channel and the first signal sending channel, the first receiving connector is coupled to the first signal receiving channel, and the first sending connector is coupled to the first signal sending channel. In this way, the first resonant body may have a signal transceiver channel (including the first signal receiving channel and the first signal sending channel) corresponding to a single band-pass frequency, namely, the first frequency.

In an optional implementation, at least one third resonant cavity and at least one fourth resonant cavity are disposed on the first resonant body, and the at least one third resonant cavity forms a second signal receiving channel. The at least one fourth resonant cavity forms a second signal sending channel, and a band-pass frequency of the second signal receiving channel and a band-pass frequency of the second signal sending channel are a second frequency. The first antenna connector is coupled to the second signal receiving channel and the second signal sending channel, the first receiving connector is coupled to the second signal receiving channel, and the first sending connector is coupled to the second signal sending channel. In this way, the first resonant body may have a signal transceiver channel (including the first signal receiving channel and the first signal sending channel) corresponding to the first frequency, and a signal transceiver channel (including the second signal receiving channel and the second signal sending channel) corresponding to the second frequency. The first frequency and the second frequency may be the same, or the first frequency and the second frequency may be different. This is not limited in this application.

In an optional implementation, a first blind hole is provided in the first resonant body, the first blind hole is coupled to the first signal receiving channel, the first signal sending channel, the second signal receiving channel, and the second signal sending channel, and the first antenna connector is disposed in the first blind hole. In this case, the first antenna connector may be disposed in the first blind hole, so that the first antenna connector may be coupled to the first signal receiving channel and the first signal sending channel, and may be coupled to the second signal receiving channel and the second signal sending channel through the first blind hole.

In an optional implementation, at least one fifth resonant cavity and at least one sixth resonant cavity are disposed on the second resonant body, and the at least one fifth resonant cavity forms a third signal receiving channel. The at least one sixth resonant cavity forms a third signal sending channel, and a band-pass frequency of the third signal receiving channel and a band-pass frequency of the third signal sending channel are a third frequency. The second antenna connector is coupled to the third signal receiving channel and the third signal sending channel, the second receiving connector is coupled to the third signal receiving channel, and the second sending connector is coupled to the third signal sending channel. In this way, the second resonant body may have a signal transceiver channel (including the third signal receiving channel and the third signal sending channel) corresponding to a single band-pass frequency, namely, the third frequency.

In an optional implementation, at least one fifth resonant cavity and at least one sixth resonant cavity are disposed on the second resonant body, and the at least one fifth resonant cavity forms a third signal receiving channel. The at least one sixth resonant cavity forms a third signal sending channel, and a band-pass frequency of the third signal receiving channel and a band-pass frequency of the third signal sending channel are a third frequency. At least one seventh resonant cavity and at least one eighth resonant cavity are disposed on the second resonant body, and the at least one seventh resonant cavity forms a fourth signal receiving channel. The at least one eighth resonant cavity forms a fourth signal sending channel, and a band-pass frequency of the fourth signal receiving channel and a band-pass frequency of the fourth signal sending channel are a fourth frequency. The second antenna connector is coupled to the third signal receiving channel, the third signal sending channel, the fourth signal receiving channel, and the fourth signal sending channel, the second receiving connector is coupled to the third signal receiving channel and the fourth signal receiving channel, and the second sending connector is coupled to the third signal sending channel and the fourth signal sending channel. In this way, the second resonant body may have a signal transceiver channel (including the third signal receiving channel and the third signal sending channel) corresponding to the third frequency, and a signal transceiver channel (including the fourth signal receiving channel and the fourth signal sending channel) corresponding to the fourth frequency. The fourth frequency and the third frequency may be the same, or the fourth frequency and the third frequency may be different. This is not limited in this application. In addition, the fourth frequency may be the same as or different from either of the first frequency and the second frequency. This is not limited in this application.

In an optional implementation, a contour shape of the first resonant body is a symmetric figure. The first antenna connector and the second antenna connector are symmetrically disposed with respect to a symmetry axis of the first resonant body, the first receiving connector and the second receiving connector are symmetrically disposed with respect to the symmetry axis of the first resonant body, and the first sending connector and the second sending connector are symmetrically disposed with respect to the symmetry axis of the first resonant body. In this way, a through hole symmetrically provided with the second antenna connector may be provided in the first resonant body, so that the second antenna connector that passes through the through hole is disposed in axial symmetry with the first antenna connector. Similarly, a through hole symmetrically provided with the second receiving connector is provided in the second resonant body, so that the first receiving connector that passes through the through hole is disposed in axial symmetry with the second receiving connector. The through hole symmetrically provided with the second sending connector is provided in the second resonant body, so that the first sending connector that passes through the through hole is disposed in axial symmetry with the second sending connector.

In an optional implementation, the first frequency and the third frequency are the same, and the second frequency and the fourth frequency are the same. In this way, the first resonant body and the second resonant body may have a same quantity of signal transceiver channels.

In an optional implementation, the filter further includes a third resonant body and at least one third connector. The third resonant body is stacked on a side that is of the second resonant body and that is away from the first resonant body. The third resonant body is decoupled from the first resonant body and the second resonant body. The first connector penetrates the third resonant body and is decoupled from the third resonant body. The second end of the first connector extends out of the third resonant body. The second connector penetrates the third resonant body and is decoupled from the third resonant body, and a second end of the second connector extends out of the third resonant body. In addition, a first end of the third connector is coupled to the third resonant body, and the third connector and the second connector are disposed on a same side of the first resonant body. Technical effects of the third resonant body and the at least one third connector are the same as those described above, and details are not described herein again.

In an optional implementation, a first gap H1 is provided between the second resonant body and a part that penetrates the second resonant body in the first connector. In this way, the first connector may not be in direct contact with the second resonant body. This helps decouple the first connector from the second resonant body.

In an optional implementation, 0 < H1 ≤ 3 mm. When the first gap H1 is greater than 3 mm, a diameter of the through hole for the connector to pass through is increased, and consequently, the through hole occupies a large layout area. Alternatively, when the first gap H1 is greater than 3 mm, a size of the first connector is reduced, which is not conducive to coupling between the first connector and another component. Therefore, when 0 < H1 ≤ 3 mm, decoupling between the first connector and the second resonant body can be ensured, and the layout area of the through hole and the size of the first connector are not affected.

In an optional implementation, a second gap H2 is provided between the first resonant body and the second resonant body. In this way, the first resonant body may not be in direct contact with the second resonant body. This helps decouple the first resonant body from the second resonant body.

In an optional implementation, 0 < H2 ≤ 3 mm. When the second gap H2 is greater than 3 mm, a distance between the first resonant body and the second resonant body is increased, and consequently, a waste of a spatial size of the filter in the thickness direction is caused. This is not conducive to a design trend of product miniaturization and product reliability. Therefore, when 0 < H2 ≤ 3 mm, decoupling between the first resonant body and the second resonant body can be ensured, and a size and reliability of the filter are not affected.

In an optional implementation, the filter further includes an insulation adhesive layer. The insulation adhesive layer is disposed between the first resonant body and the second resonant body, and the insulation adhesive layer is adhered to the first resonant body and the second resonant body. In this way, the insulation adhesive layer is disposed, so that the first resonant body may not be in direct contact with the second resonant body. This helps decouple the first resonant body from the second resonant body.

In an optional implementation, a thickness D of the insulation adhesive layer is 0 < D ≤ 3 mm. When the thickness D of the insulation adhesive layer is greater than 3 mm, a distance between the first resonant body and the second resonant body is increased, and consequently, a waste of a spatial size of the filter in the thickness direction is caused. This is not conducive to a design trend of product miniaturization and product reliability. Similarly, when 0 < D ≤ 3 mm, decoupling between the first resonant body and the second resonant body can be ensured, and a size and reliability of the filter are not affected.

In an optional implementation, a first gap H1 is provided between the second resonant body and a part that penetrates the second resonant body in the first antenna connector. A technical effect of the first gap H1 is the same as that described above, and details are not described herein again.

In an optional implementation, a first gap H1 is provided between the first resonant body and a part that penetrates the first resonant body in the second antenna connector. A technical effect of the first gap H1 is the same as that described above, and details are not described herein again.

According to another aspect of this application, an antenna apparatus is provided, including a circuit board and any one of the foregoing filters, where the filter is coupled to the circuit board. The foregoing antenna apparatus has a same technical effect as the filter provided in the foregoing embodiments, and details are not described herein again.

In an optional implementation, the at least one first connector in the filter may include the first receiving connector and the first sending connector. In addition, the filter may further include the first antenna connector, and the first antenna connector is coupled to the first resonant body. The first signal receiving channel and the first signal sending channel are disposed on the first resonant body, and the band-pass frequency of the first signal receiving channel and the band-pass frequency of the first signal sending channel are the first frequency. The second signal receiving channel and the second signal sending channel are disposed on the first resonant body, and the band-pass frequency of the second signal receiving channel and the band-pass frequency of the second signal sending channel are the second frequency. The first antenna connector is coupled to the first signal receiving channel, the first signal sending channel, the second signal receiving channel, and the second signal sending channel. In addition, the first receiving connector is coupled to the first signal receiving channel and the second signal receiving channel, and the first sending connector is coupled to the first signal sending channel and the second signal sending channel. Based on this, the antenna apparatus further includes a frequency divider and a frequency combiner. The frequency divider is disposed on the circuit board, and the frequency divider is coupled to the circuit board and the first receiving connector. The frequency combiner is disposed on the circuit board, and the frequency combiner is coupled to the circuit board and the first sending connector. In this way, an electrical signal of the first frequency and an electrical signal of the second frequency that are received by the first receiving connector from the first antenna connector may be separately output to a receiving circuit on the circuit board under frequency division of the frequency divider, and the electrical signal of the first frequency and the electrical signal of the second frequency are separately output. In addition, the electrical signal of the first frequency and the electrical signal of the second frequency that are output by a sending circuit on the circuit board may be transmitted to the first sending connector and then to the first antenna connector after frequency combination is performed by the frequency combiner.

According to another aspect of this application, a communication device is provided, including a mounting bracket and any one of the foregoing antenna apparatuses, where the antenna apparatus is disposed on the mounting bracket. The communication device has same technical effects as the antenna apparatus provided in the foregoing embodiments. Details are not described herein again.

### BRIEF DESCRIPTION OF DRAWINGS

FIG. 1 is a diagram of a structure of a communication system architecture according to an embodiment of this application;

FIG. 2 is a diagram of a structure of a communication device in FIG. 1;

FIG. 3A is a diagram of a structure of an antenna apparatus in FIG. 2;

FIG. 3B is diagram of another structure of an antenna apparatus in FIG. 2;

FIG. 4A is a diagram of a connection between a filter and a circuit board according to an embodiment of this application;

FIG. 4B is a diagram of another connection between a filter and a circuit board according to an embodiment of this application;

FIG. 5 is a diagram of a structure of a filter according to an embodiment of this application;

FIG. 6 is a diagram of a structure of a dielectric filter according to an embodiment of this application;

FIG. 7 is a diagram of stacking of a first resonant body and a second resonant body in FIG. 5;

FIG. 8 is a diagram of another structure of a filter according to an embodiment of this application;

FIG. 9A is a diagram of another structure of a filter according to an embodiment of this application;

FIG. 9B is a diagram of another structure of a filter according to an embodiment of this application;

FIG. 10 is a diagram of another structure of a filter according to an embodiment of this application;

FIG. 11 is a diagram of stacking of a first resonant body and a second resonant body in FIG. 10;

FIG. 12 is a diagram of another structure of a filter according to an embodiment of this application;

FIG. 13 is a diagram of a manner of disposing a signal transceiver channel on a first resonant body according to an embodiment of this application;

FIG. 14 is a diagram of another manner of disposing a signal transceiver channel on a first resonant body according to an embodiment of this application;

FIG. 15 is a top view obtained in a direction A in FIG. 14;

FIG. 16 is diagram of another connection between a filter and a circuit board according to an embodiment of this application;

FIG. 17 is a diagram of a manner of disposing signal transceiver channels on a first resonant body and a second resonant body according to an embodiment of this application;

FIG. 18 is a diagram of a connector and a signal transceiver channel on a dielectric filter according to a related technology;

FIG. 19 is a diagram of another manner of disposing signal transceiver channels on a first resonant body and a second resonant body according to an embodiment of this application;

FIG. 20 is a diagram of another manner of disposing signal transceiver channels on a first resonant body and a second resonant body according to an embodiment of this application; and

FIG. 21 is a diagram of another structure of a filter according to an embodiment of this application.

Reference numerals:

01: communication system architecture; 02: communication device; 03: terminal device; 10: antenna apparatus; 20: mounting bracket; 21: mounting pole; 22: adjustment bracket; 101: radome; 102: antenna board; 1021: radiator; 30: filter; 103: circuit board; 104: shielding cover; 1031: TX circuit; 1032: RX circuit; 301: first resonant body; 302: second resonant body; 311: first connector; 312: second connector; 3001: dielectric block; 3002: conductive layer; 3003: blind hole; 400: through hole; 50: insulation adhesive layer; 311RX: first receiving connector; 311TX: first sending connector; 312RX: second receiving connector; 312TX: second sending connector; 321: first antenna connector; 322: second antenna connector; 601: first resonant cavity; 711: first signal receiving channel; 602: second resonator; 712: first signal sending channel; 603: third resonant cavity; 721: second signal receiving channel; 604: fourth resonant cavity; 722: second signal sending channel; 401: first blind hole; 402: coupling cavity; 1033: frequency divider; 1034: frequency combiner; 605: fifth resonant cavity; 731: third signal receiving channel; 606: sixth resonant cavity; 732: third signal sending channel; 607: seventh resonant cavity; 741: fourth signal receiving channel; 608: eighth resonant cavity; 742: fourth signal sending channel; 303: third resonant body; 313RX: third receiving connector; 313TX: third sending connector; and 323: third antenna connector.

### DESCRIPTION OF EMBODIMENTS

The following describes the technical solutions in embodiments of this application with reference to the accompanying drawings in embodiments of this application. It is clear that the described embodiments are merely a part rather than all of embodiments of this application.

The terms such as "first" and "second", below are merely for convenience of description, and are not to be construed as indicating or implying relative importance or implicitly indicating a quantity of indicated technical features. Therefore, a feature limited by "first", "second", or the like may explicitly or implicitly include one or more features. In the descriptions of this application, unless otherwise stated, "a plurality of" means two or more than two.

In this application, unless otherwise expressly specified and limited, the term "connection" should be understood in a broad sense. For example, "connection" may be a fixed mechanical connection, or may be a detachable mechanical connection or an integration. Alternatively, "connection" may be a direct connection, or may be an indirect connection via an intermediate medium.

In addition, unless otherwise specified and limited, the term "coupling" should be understood in a broad sense. For example, "coupling" may be a direct electrical connection between two components, for example, two components are in physical contact and electrically connected, and may also be understood that different components in a line structure are electrically connected through a physical line that can transmit an electrical signal, for example, a printed circuit board (printed circuit board, PCB) copper foil or a conducting wire, to transmit the electrical signal. Alternatively, "coupling" may be an indirect electrical connection between two components through an intermediate medium. Alternatively, "coupling" may be an electrical connection between two components in a spaced/non-contact manner. For example, the two components are electrically connected through capacitive coupling, to transmit the electrical signal. In addition, in embodiments of this application, the term "decoupling" means that there is no direct or indirect electrical connection relationship between two components. Therefore, no electrical signal is transmitted between two decoupled components.

In embodiments of this application, orientation terms such as "upper" and "lower" may include but are not limited to being defined relative to placement orientations of components shown in the accompanying drawings. It should be understood that these directional terms may be relative concepts and are used for relative descriptions and clarifications, and may vary accordingly based on changes of the placement orientations of the components in the accompanying drawings.

In the accompanying drawings of embodiments of this application, an assembly is represented by using a guide line with an arrow, a component is represented by using only a guide line, and a hollow structure like an opening or a hole is represented by using a guide line with a wavy line at an end.

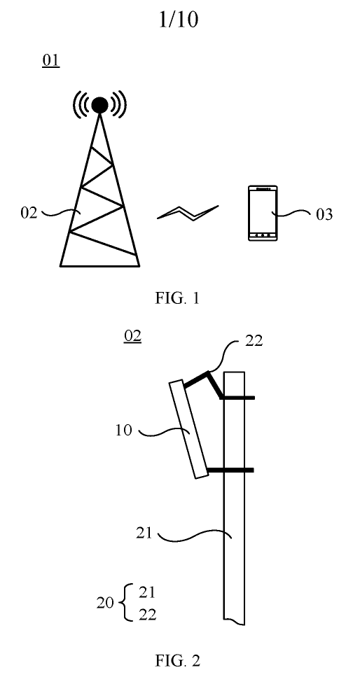

FIG. 1 shows a communication system architecture 01 according to an embodiment of this application. The communication system architecture 01 may include a communication device 02 and a terminal device 03. The communication device 02 may perform wireless communication with the terminal device 03. For example, the communication device 02 may include a base station. The base station is configured to perform cell coverage of a radio signal to connect a terminal device to a wireless network radio frequency end. Based on this, for example, the base station may be a base transceiver station (base transceiver station, BTS) in a global system for mobile communication (global system of mobile communication, GSM) or a code division multiple access (code division multiple access, CDMA) system. Alternatively, for another example, the base station may be a NodeB (NodeB, NB) in a wideband code division multiple access (wideband code division multiple access wireless, WCDMA) system. Alternatively, for another example, the base station may be an evolutional NodeB (evolutional NodeB, eNB) in a long term evolution (long term evolution, LTE) system, or a radio controller in a cloud radio access network (cloud radio access network, CRAN) scenario. Alternatively, the base station may be a relay station, an access point, a vehicle-mounted device, a wearable device, or a base station in a 5G network, or may be a base station or the like in a future evolved public land mobile network (public land mobile network, PLMN), for example, a new radio base station. This is not limited in embodiments of this application.

In addition, the terminal device 03 may be a mobile phone (mobile phone), a tablet computer (pad), a notebook computer, a smart home, an intelligent wearable device (for example, a smartwatch, a smart band, smart glasses, or a smart helmet), a virtual reality (virtual reality, VR) device, an augmented reality (augmented reality, AR) device, or the like. The terminal device 03 may alternatively be a handheld terminal device having a wireless communication function, a compute device, another processing device connected to a wireless modem, a vehicle-mounted device, a device in a 5G network, a terminal device in a future evolved PLMN, or the like. This is not limited in embodiments of this application.

When the communication device 02 is a base station, the communication device 02 may include an antenna apparatus 10 and a mounting bracket 20 shown in FIG. 2. For example, the mounting bracket 20 may include a mounting pole 21, and the mounting pole may be configured to fasten and support the antenna apparatus 10. In addition, the mounting bracket 20 may further include an adjustment bracket 22. The antenna apparatus 10 may be connected to the mounting pole 21 through the adjustment bracket 22. The adjustment bracket 22 may adjust a pitch angle of the antenna apparatus 10 relative to the mounting pole.

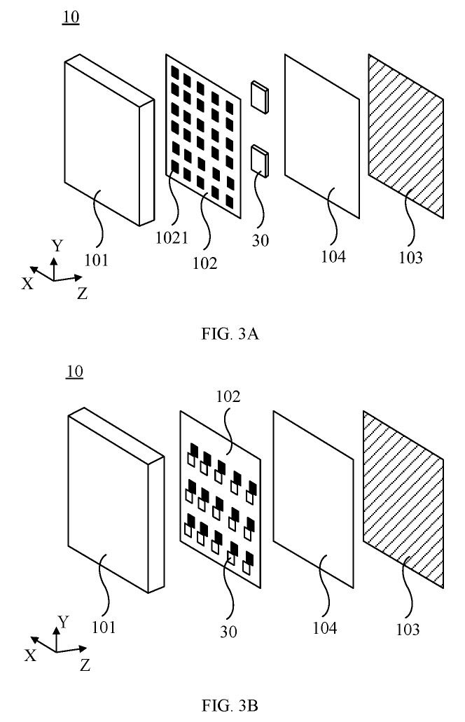

Based on this, in some embodiments of this application, the antenna apparatus 10 shown in FIG. 3A may include a radome 101, an antenna board 102, a filter 30, a shielding cover 104, and a circuit board 103. FIG. 3A is described by using an example in which the filter 30 is disposed between the antenna board 102 and the shielding cover 104. In some other embodiments of this application, as shown in FIG. 3B, the filter 30 may be disposed on a side that is of the antenna board 102 and that is away from the circuit board 103. In FIG. 3A, a Z direction may be a thickness direction of the antenna apparatus 10 and each component in the antenna apparatus 10, and an X direction and a Y direction may be respectively a width direction and a length direction of the antenna apparatus 10 and each component in the antenna apparatus 10. An XY plane may be parallel to a surface of the circuit board 103. Meanings of X, Y, and Z coordinates in the following accompanying drawings in embodiments of this application are the same as those described above, and details are not described again.

In addition, still as shown in FIG. 3A, the antenna board 102 may include a radiator 1021, and a radiation element including a plurality of radiators 1021 can radiate and receive an antenna signal. The radome 101 is disposed on the antenna board 102, and an accommodation cavity configured to accommodate the antenna board 102 and the filter 30 may be formed between the radome 101 and the shielding cover 104. The radome 101 and the shielding cover 104 may have a good electromagnetic wave penetration characteristic, to avoid impact of external electromagnetic interference on the antenna board 102 and the filter. In addition, the radome 101 can further resist impact of an external environment of the antenna apparatus 10.

Based on this, the filter 30 shown in FIG. 3A may be a dielectric filter (dielectric filter, DF). The dielectric filter is an electronic element used for signal filtering. A dielectric material in the dielectric filter may be a non-metal material, for example, an insulation material like ceramic or a polymer. These materials have good insulation performance and capacitance characteristics. In the dielectric filter, the dielectric material is usually used to make a capacitor, and different capacitors may have different capacitance values and operating frequency ranges. When an electrical signal received or sent by the radiator 1021 on the antenna board 102 passes through the dielectric filter, an electric field is generated in the capacitor in the dielectric filter 30. Electrical signals of different frequencies are shielded or pass through under action of the electric field, so that the electrical signals can be filtered. The filter 30 may be at least one of a band-pass filter (band-pass filter), a low-pass filter (low-pass filter), a high-pass filter (high-pass filter), or a band-stop filter (band-stop filter). This is not limited in this application. For ease of description, the following uses an example in which the filter 30 is a band-pass filter for description.

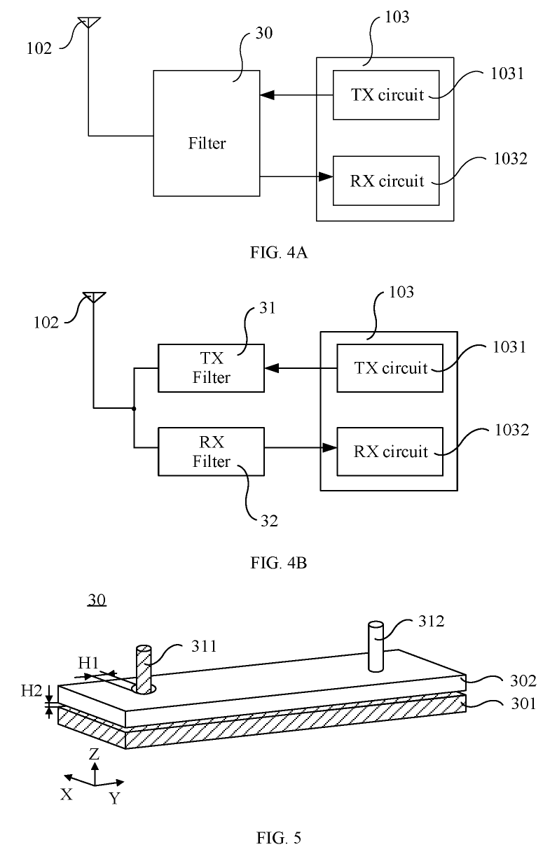

For example, as shown in FIG. 4A, the filter 30 may be coupled to the antenna board 102 and the circuit board 103. The circuit board 103 may be a printed circuit board (printed circuit board, PCB), and a TX circuit 1031 and an RX circuit 1032 may be disposed on the circuit board 103. The TX circuit 1031 may filter a to-be-sent electrical signal through the filter 30, and then send the to-be-sent electrical signal through the antenna board 102. Alternatively, an electrical signal received by the antenna board 102 may be filtered through the filter 30, and then transmitted to the RX circuit 1032 for signal processing. The filter 30 shown in FIG. 4A may also be referred to as a duplexer.

Alternatively, for another example, the antenna apparatus 10 may include a plurality of filters, which are respectively the TX filter 31 and the RX filter 32 shown in FIG. 4B. The TX filter 31 may be coupled to the antenna board 102 and the TX circuit 1031. The TX circuit 1031 may filter the to-be-sent electrical signal through the TX filter 31, and then send the to-be-sent electrical signal through the antenna board 102. In addition, the RX filter 32 may be coupled to the antenna board 102 and the RX circuit 1032. The electrical signal received by the antenna board 102 may be filtered through the RX filter 32, and then transmitted to the RX circuit 1032 for signal processing.

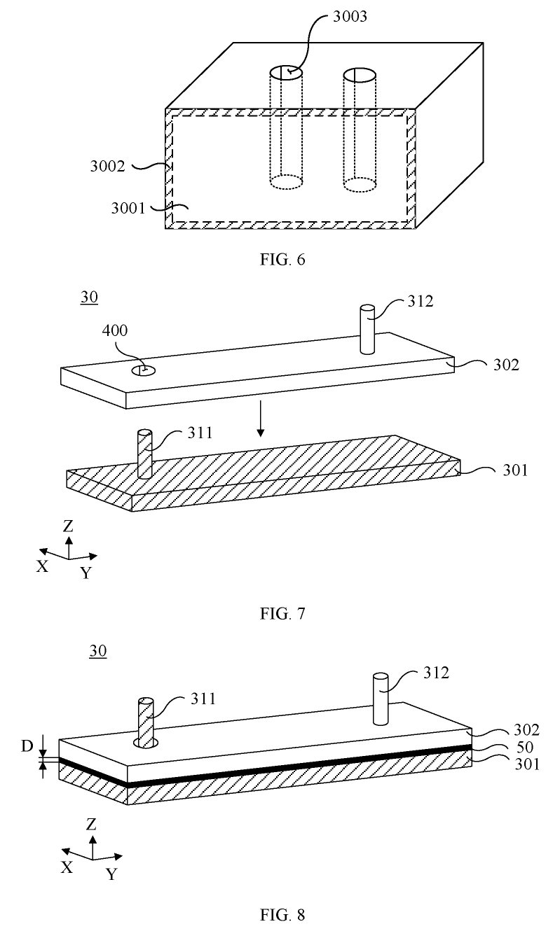

The following describes a structure of the filter 30 by using an example. In some embodiments of this application, as shown in FIG. 5, the filter 30 may include a first resonant body 301, a second resonant body 302, at least one first connector 311, and at least one second connector 312. At least one of the first resonant body 301 and the second resonant body 302 may include a dielectric block 3001 shown in FIG. 6 and a conductive layer 3002 covering a surface of the dielectric block 3001. The dielectric block 3001 is made of an insulation material like the foregoing ceramic or polymer. A material of the conductive layer 3002 may be a metal material, for example, silver. The conductive layer 3002 may be formed by electroplating metal on the surface of the dielectric block 3001 by using an electroplating process.

To adjust a resonance frequency of the resonant body, still as shown in FIG. 6, at least one blind hole 3003 may be provided in the resonant body (FIG. 6 is described by using two blind holes as an example), and the blind hole 3003 may form a resonant cavity with a part of dielectric around the blind hole 3003. A resonance frequency of the resonant cavity is related to parameters such as a dielectric constant of a material of the dielectric block 3001, and a diameter and a depth of the blind hole 3003. Therefore, the resonance frequency of the resonant body may be adjusted by adjusting the foregoing parameters. For example, the resonance frequency may be inversely proportional to a square root of the dielectric constant of the dielectric block 3001. Therefore, when a size of the resonant cavity is the same, a larger dielectric constant of the dielectric block 3001 indicates a lower resonance frequency. Alternatively, for another example, when the dielectric constant of the dielectric block 3001 is the same, a larger (or smaller) depth of the blind hole 3003 indicates a lower (or higher) resonance frequency; and a smaller (or larger) diameter of the blind hole 3003 indicates a higher (or lower) resonance frequency. In addition, a density of the blind hole 3003 may determine a coupling degree of an electrical signal transmitted on the resonant body. For example, a smaller spacing between two adjacent blind holes 3003 indicates that an electrical signal is more likely to be coupled from one blind hole to another blind hole.

Based on this, still as shown in FIG. 5, the first resonant body 301 may be stacked with the second resonant body 302, and the first resonant body 301 is decoupled from the second resonant body 302. In this case, there is no direct or indirect electrical connection relationship between the first resonant body 301 and the second resonant body 302. Therefore, an electrical signal on the first resonant body 301 is not easily transmitted to the second resonant body 302, and an electrical signal on the second resonant body 302 is not easily transmitted to the first resonant body 301 either. In this way, electrical signals separately transmitted on the first resonant body 301 and the second resonant body 302 are independent of each other.

Based on this, as shown in FIG. 7, a first end (an end facing the first resonant body 301) of the first connector 311 may be coupled to the first resonant body 301. In this case, the first resonant body 301 may be coupled to the antenna board 102 or the circuit board 103 (as shown in FIG. 3A) through the first connector 311. An electrical signal received by the first connector 311 may be transmitted to the first resonant body 301 coupled to the first connector 311. Alternatively, the electrical signal on the first resonant body 301 may be output through the first connector 311.

Similarly, a first end (an end facing the second resonant body 302) of the second connector 312 is coupled to the second resonant body 302. In this case, the second resonant body 302 may be coupled to the antenna board 102 or the circuit board 103 (as shown in FIG. 3A) through the second connector 312. An electrical signal received by the second connector 312 may be transmitted to the second resonant body 302 coupled to the second connector 312. Alternatively, the electrical signal on the second resonant body 302 may be output through the second connector 312.

To stack the first resonant body 301 and the second resonant body 302, still as shown in FIG. 7, a through hole 400 that penetrates the second resonant body 302 may be provided in the second resonant body 302. In a direction of an arrow in FIG. 7, when the second resonant body 302 is stacked above the first resonant body 301, the first connector 311 may penetrate the through hole 400, to penetrate the second resonant body 302. In this case, a second end (an end away from the first resonant body 301) of the first connector 311 extends out of the second resonant body 302, and the first connector 311 and the second connector 312 are disposed on a same side (namely, an upper side of the first resonant body 301) of the first resonant body 301.

In addition, because the first resonant body 301 and the second resonant body 302 are in a decoupled state due to no electrical signal transmission, the first connector 311 may be decoupled from the second resonant body 302. Similarly, there is no direct or indirect electrical connection relationship between the first connector 311 and the second resonant body 302.

Based on this, to decouple the first connector 311 from the second resonant body 302, in some embodiments of this application, as shown in FIG. 5, a first gap H1 may be provided between the second resonant body 302 and a part that penetrates the second resonant body 302 in the first connector 311. In other words, the first gap H1 may be provided between the first connector 311 and a hole wall of the through hole 400 (as shown in FIG. 7). In this way, the first connector 311 may not be in direct contact with the second resonant body 302. This helps decouple the first connector 311 from the second resonant body 302.

For example, the first gap H1 may satisfy the following range: 0 < H1 ≤ 3 mm. When the first gap H1 is greater than 3 mm, a diameter of the through hole 400 (as shown in FIG. 7) is increased, and consequently, the through hole 400 occupies a large layout area. Alternatively, when the first gap H1 is greater than 3 mm, a size of the first connector 311 is reduced. This is not conducive to coupling between the first connector 311 and another component (for example, the antenna board 102 and the circuit board 103 in FIG. 3A). Therefore, when 0 < H1 ≤ 3 mm, decoupling between the first connector 311 and the second resonant body 302 can be ensured, and a layout area of the through hole 400 (as shown in FIG. 7) and a size of the first connector 311 are not affected.

In addition, in some embodiments of this application, to decouple the first resonant body 301 from the second resonant body 302, still as shown in FIG. 5, a second gap H2 may be provided between the first resonant body 301 and the second resonant body 302. In this way, the first resonant body 301 may not be in direct contact with the second resonant body 302. This helps decouple the first resonant body 301 from the second resonant body 302.

For example, the second gap H2 may satisfy the following range: 0 < H2 ≤ 3 mm. When the second gap H2 is greater than 3 mm, a distance between the first resonant body 301 and the second resonant body 302 is increased, and consequently, a waste of a spatial size of the filter 30 in a thickness direction (a direction in which the first resonant body 301 points to the second resonant body 302) is caused. This is not conducive to a design trend of product miniaturization and product reliability. Therefore, when 0 < H2 ≤ 3 mm, decoupling between the first resonant body 301 and the second resonant body 302 can be ensured, and a size and reliability of the filter 30 are not affected.

Alternatively, in some other embodiments of this application, to decouple the first resonant body 301 from the second resonant body 302, the filter 30 may further include an insulation adhesive layer 50 shown in FIG. 8. The insulation adhesive layer 50 may be prepared by using an adhesive insulation material, the insulation adhesive layer 50 may be disposed between the first resonant body 301 and the second resonant body 302, and the insulation adhesive layer 50 may be adhered to the first resonant body 301 and the second resonant body 302. In this way, the insulation adhesive layer 50 is disposed, so that the first resonant body 301 may not be in direct contact with the second resonant body 302. This helps decouple the first resonant body 301 from the second resonant body 302.

For example, a thickness D of the insulation adhesive layer 50 may satisfy the following range: 0 < D ≤ 3 mm. When the thickness D of the insulation adhesive layer 50 is greater than 3 mm, a distance between the first resonant body 301 and the second resonant body 302 is increased, and consequently, a waste of a spatial size of the filter 30 in a thickness direction (a direction in which the first resonant body 301 points to the second resonant body 302) is caused. This is not conducive to a design trend of product miniaturization and product reliability. Similarly, when 0 < D ≤ 3 mm, decoupling between the first resonant body 301 and the second resonant body 302 can be ensured, and a size and reliability of the filter 30 are not affected.

In conclusion, as shown in FIG. 5, the filter 30 provided in this embodiment of this application may include the first resonant body 301 and the second resonant body 302 that are stacked, the first connector 311 coupled to the first resonant body 301, and the second connector 312 coupled to the second resonant body 302. The first connector 311 may send or receive an electrical signal on the first resonant body 301, and the second connector 312 may send or receive an electrical signal on the second resonant body 302. A frequency of the electrical signal on the first resonant body 301 may be the same as or different from a frequency of the electrical signal on the second resonant body 302. In addition, the first resonant body 301 is decoupled from the second resonant body 302, and the first connector 311 coupled to the first resonant body is decoupled from the second resonant body 302. In this way, in one aspect, the first resonant body 301 and the second resonant body 302 are independent of each other, and an electrical signal transmitted on the first resonant body 301 and an electrical signal transmitted on the second resonant body 302 do not affect each other. In this case, the first resonant body 301 and the second resonant body 302 may have independent signal transceiver channels, so that a quantity of signal transceiver channels can be effectively increased, and a probability that the quantity of signal transceiver channels of the filter 30 is increased can reach 100%.

In another aspect, still as shown in FIG. 5, the first resonant body 301 is stacked with the second resonant body 302, and the first connector 311 coupled to the first resonant body 301 can penetrate the second resonant body 302, and the first connector 311 and the second connector 312 are disposed on a same side of the first resonant body 301. In this case, the first resonant body 301 is stacked with the second resonant body 302 in the thickness direction of the filter 30, namely, the Z direction, so that an area of the filter 30 on an XY plane can be reduced. The XY plane shown in FIG. 3A may be parallel to a surface of the circuit board 103. In this way, when it is ensured that a quantity of channels can be increased, a board layout area occupied by the filter 30 on the surface of the circuit board 103 can be further reduced, and a problem that the antenna apparatus and the communication device having the filter 30 have a large size is alleviated. For example, when the first resonant body 301 and the second resonant body 302 each may have an independent signal transceiver channel, in comparison with a solution in which different signal transceiver channels are integrated into a same resonant body, when the filter 30 provided in this embodiment of this application includes the first resonant body 301 and the second resonant body 302 that are stacked, an area of the filter 30 on the XY plane may be reduced by 50%.

In another aspect, when the first resonant body 301 and the second resonant body 302 are stacked, and the first resonant body 301 and the second resonant body 302 each may have an independent signal transceiver channel, in comparison with a solution in which different signal transceiver channels are integrated into a same resonant body, either of the first resonant body 301 and the second resonant body 302 in this embodiment of this application has a small size. This helps reduce difficulty in forming a large-sized resonant body.

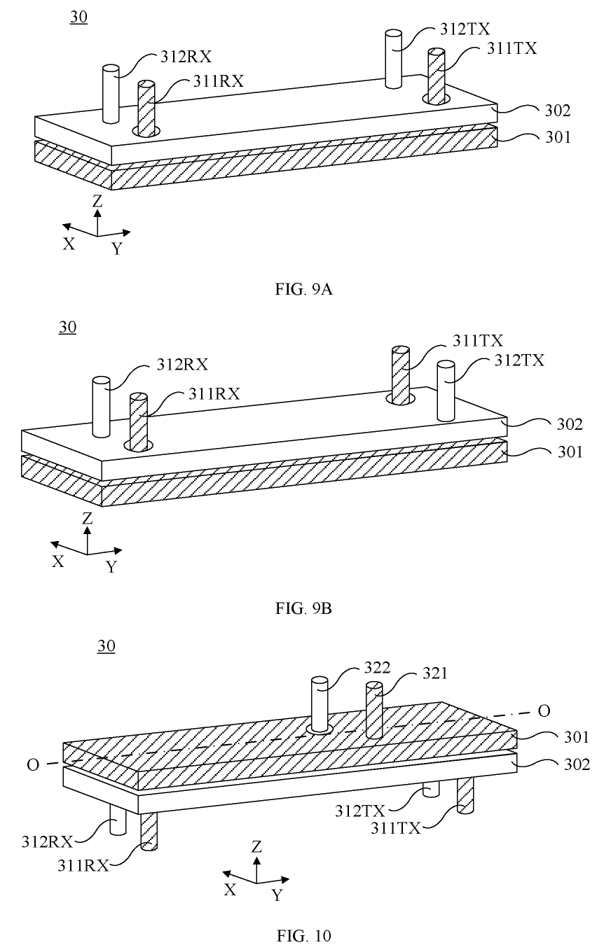

The foregoing is described by using an example in which the filter 30 shown in FIG. 5 includes one first connector 311 and one second connector 312. In some other embodiments of this application, as shown in FIG. 9A, in the filter 30, at least one first connector coupled to the first resonant body 301 may include a first receiving connector 311RX and a first sending connector 311TX. In addition, at least one second connector coupled to the second resonant body 302 may include a second receiving connector 312RX and a second sending connector 312TX.

FIG. 9A is described by using an example in which the first receiving connector 311RX and the first sending connector 311TX are close to a same side of the resonant body (the first resonant body 301 or the second resonant body 302), and the second receiving connector 312RX and the second sending connector 312TX are close to the other side of the resonant body. In some other embodiments of this application, as shown in FIG. 9B, the first receiving connector 311RX and the first sending connector 311TX may be respectively disposed at diagonal positions of the resonant body. Similarly, the second receiving connector 312RX and the second sending connector 312TX may also be respectively disposed at diagonal positions of the resonant body. For ease of description, the following uses the structure shown in FIG. 9A as an example for description.

In addition, the first receiving connector 311RX and the second receiving connector 312RX may be close to a same side of the resonant body, as shown in FIG. 9A or FIG. 9B, or the first receiving connector 311RX and the second receiving connector 312RX may be respectively close to different sides of the resonant body. Similarly, the first sending connector 311TX and the second sending connector 312TX may be close to a same side of the resonant body, as shown in FIG. 9A or FIG. 9B, or the first sending connector 311TX and the second sending connector 312TX may be respectively close to different sides of the resonant body.

The foregoing is merely an example of deposition positions of the first receiving connector 311RX, the first sending connector 311TX, the second receiving connector 312RX, and the second sending connector 312TX, and does not constitute a limitation on positions of the foregoing connectors.

Based on this, the first receiving connector 311RX and the first sending connector 311TX are respectively located on a same side of the first resonant body 301. As described above, both the first receiving connector 311RX and the first sending connector 311TX may penetrate the second resonant body 302, and partially extend out of the second resonant body 302. Both the first receiving connector 311RX and the first sending connector 311TX are decoupled from the second resonant body 302.

For example, when the filter 30 in FIG. 3B is disposed on a side that is of the antenna board 102 and that is away from the circuit board 103, the first receiving connector 311RX shown in FIG. 9A may be coupled to the antenna board 102 (as shown in FIG. 3B), so that an electrical signal from the antenna board 102 (as shown in FIG. 3B) is transmitted to the first resonant body 301 through the first receiving connector 311RX. The first sending connector 311TX may be coupled to the circuit board 103, so that an electrical signal from the first resonant body 301 is transmitted to the circuit board 103 (as shown in FIG. 3B) through the first sending connector 311TX. In this case, the first resonant body 301 can filter the electrical signal from the antenna board 102 (as shown in FIG. 3B), and then transmit a filtered electrical signal to the circuit board 103 (as shown in FIG. 3B), so that the circuit board 103 can receive the electrical signal from the antenna board 102 and perform signal processing. In this case, the first resonant body 301 may be used as the RX filter 32 shown in FIG. 4B.

Alternatively, for another example, when the filter 30 in FIG. 3B is disposed on a side that is of the antenna board 102 and that is away from the circuit board 103, the first receiving connector 311RX shown in FIG. 9A may be coupled to the circuit board 103, so that an electrical signal from the circuit board 103 (as shown in FIG. 3B) is transmitted to the first resonant body 301 through the first receiving connector 311RX. The first sending connector 311TX may be coupled to the antenna board 102 (as shown in FIG. 3B), so that an electrical signal from the first resonant body 301 is transmitted to the antenna board 102 (as shown in FIG. 3B) through the first sending connector 311TX for signal transmission. In this case, the first resonant body 301 can filter the electrical signal from the circuit board 103 (as shown in FIG. 3B), and then transmit a filtered electrical signal to the antenna board 102 (as shown in FIG. 3B), so that the antenna board 102 can send the electrical signal from the circuit board 103. In this case, the first resonant body 301 may be used as the TX filter 31 shown in FIG. 4B.

In addition, still as shown in FIG. 9A, the second receiving connector 312RX and the first receiving connector 311RX may be disposed on a same side of the first resonant body 301. The second sending connector 312TX and the first sending connector 311TX are disposed on a same side of the first resonant body 301. Both the second receiving connector 312RX and the second sending connector 312TX are coupled to the second resonant body 302. Similarly, when the filter 30 is disposed on the side that is of the antenna board 102 and that is away from the circuit board 103 in FIG. 3B, the second receiving connector 312RX shown in FIG. 9A may be coupled to the antenna board 102 (as shown in FIG. 3B), so that the electrical signal from the antenna board 102 (as shown in FIG. 3B) is transmitted to the second resonant body 302 through the second receiving connector 312RX. The second sending connector 312TX may be coupled to the circuit board 103, so that an electrical signal from the second resonant body 302 is transmitted to the circuit board 103 (as shown in FIG. 3B) through the second sending connector 312TX. In this case, the second resonant body 302 can filter the electrical signal from the antenna board 102 (as shown in FIG. 3B), and then transmit a filtered electrical signal to the circuit board 103 (as shown in FIG. 3B), so that the circuit board 103 can receive the electrical signal from the antenna board 102 and perform signal processing. In this case, the second resonant body 302 may be used as the RX filter 32 shown in FIG. 4B.

Alternatively, for another example, when the filter 30 is disposed on the side that is of the antenna board 102 and that is away from the circuit board 103 in FIG. 3B, the second receiving connector 312RX shown in FIG. 9A may be coupled to the circuit board 103, so that an electrical signal from the circuit board 103 (as shown in FIG. 3B) is transmitted to the second resonant body 302 through the second receiving connector 312RX. The second sending connector 312TX may be coupled to the antenna board 102 (as shown in FIG. 3B), so that an electrical signal from the second resonant body 302 is transmitted to the antenna board 102 (as shown in FIG. 3B) through the second sending connector 312TX for signal transmission. In this case, the second resonant body 302 can filter the electrical signal from the circuit board 103 (as shown in FIG. 3B), and then transmit a filtered electrical signal to the antenna board 102 (as shown in FIG. 3B), so that the antenna board 102 can send the electrical signal from the circuit board 103. In this case, the second resonant body 302 may be used as the TX filter 31 shown in FIG. 4B.

The foregoing is described by using an example in which either of the first resonant body 301 and the second resonant body 302 shown in FIG. 9A may be the TX filter 31 or the RX filter 32 shown in FIG. 4B. In some other embodiments of this application, any resonant body in the filter 30 provided in this embodiment of this application may alternatively be a duplexer. The following describes a structure of the filter 30 by using an example.

For example, as shown in FIG. 10, when the filter 30 includes the first resonant body 301 and the second resonant body 302 that are stacked, in addition to the first receiving connector 311RX, the first sending connector 311TX, the second receiving connector 312RX, and the second sending connector 312TX, the filter 30 may further include a first antenna connector 321 and a second antenna connector 322.

A first end (facing the first resonant body 301) of the first antenna connector 321 is coupled to the first resonant body 301, so that signal transmission can be performed between the first antenna connector 321 and the first resonant body 301. The first antenna connector 321 and the first receiving connector 311RX may be respectively located on two opposite sides of the first resonant body 301.

Based on this, when the filter 30 is disposed between the antenna board 102 and the circuit board 103 in FIG. 3A, a second end (an end away from the first resonant body 301) of the first antenna connector 321 shown in FIG. 10 may be coupled to the antenna board 102 (as shown in FIG. 3A), so that an electrical signal from the antenna board 102 (as shown in FIG. 3B) is transmitted to the first resonant body 301 through the first antenna connector 321. The first resonant body 301 may filter the electrical signal from the antenna board 102, or transmit a signal obtained through filtering by the first resonant body 301 to the antenna board 102 (as shown in FIG. 3B) through the first antenna connector 321 for sending.

In this case, the first receiving connector 311RX shown in FIG. 10 may be coupled to the RX circuit 1032 in the circuit board 103 shown in FIG. 4A, so that the electrical signal obtained through filtering by the first resonant body 301 is transmitted to the RX circuit 1032 in the circuit board 103 (as shown in FIG. 4A) through the first receiving connector 311RX for signal processing. In addition, the first sending connector 311TX shown in FIG. 10 may be coupled to the TX circuit 1031 in the circuit board 103 shown in FIG. 4A, so that the electrical signal from the circuit board 103 is transmitted to the first resonant body 301 for filtering, and then is transmitted to the antenna board 102 (as shown in FIG. 3B) through the first antenna connector 321 for sending. In this way, the first resonant body 301 may filter the electrical signal received by the antenna board 102, and may also filter an electrical signal to be sent by the antenna board 102. Therefore, the first resonant body 301 may be the foregoing duplexer.

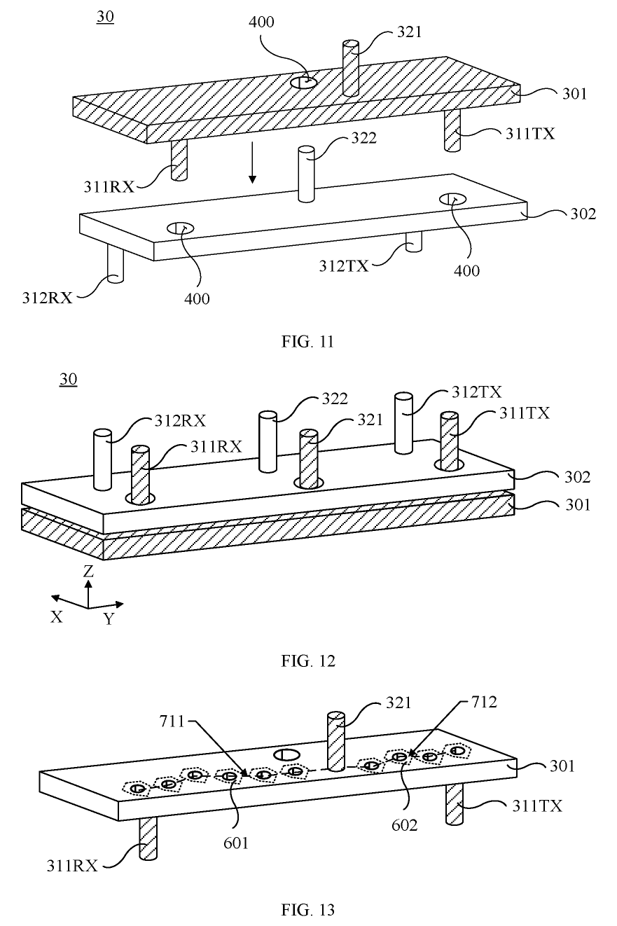

In addition, as shown in FIG. 11, a through hole 400 may also be provided in the first resonant body 301. When the first resonant body 301 and the second resonant body 302 are stacked, the second antenna connector 322 may pass through the through hole 400 in an arrow direction, to penetrate the first resonant body 301. In addition, the second antenna connector 322 may be decoupled from the first resonant body 301, so that there is no direct or indirect electrical connection relationship between the second antenna connector 322 and the first resonant body 301. Similarly, it may be learned that the first gap H1 (as shown in FIG. 5) may be provided between a part that penetrates the first resonant body 301 in the second antenna connector 322 and the first resonant body 301. A value of the first gap H1 is the same as that described above, and details are not described herein again.

Based on this, still as shown in FIG. 10, a first end (an end facing the second resonant body 302) of the second antenna connector 322 is coupled to the second resonant body 302, so that an electrical signal can be transmitted between the second antenna connector 322 and the second resonant body 302. The second antenna connector 322 and the second receiving connector 312RX may be respectively located on two opposite sides of the second resonant body 302.

In addition, similarly, it may be learned that, when the filter 30 is disposed between the antenna board 102 and the circuit board 103 in FIG. 3A, a second end (an end away from the second resonant body 302) of the second antenna connector 322 shown in FIG. 10 may be coupled to the antenna board 102 (as shown in FIG. 3A), so that an electrical signal from the antenna board 102 (as shown in FIG. 3B) is transmitted to the second resonant body 302 through the second antenna connector 322. The second resonant body 302 may filter the electrical signal from the antenna board 102, or transmit a signal obtained through filtering by the second resonant body 302 to the antenna board 102 (as shown in FIG. 3B) through the second antenna connector 322 for sending.

In this case, the second receiving connector 312RX shown in FIG. 10 may be coupled to the RX circuit 1032 in the circuit board 103 shown in FIG. 4A, so that the electrical signal obtained through filtering by the second resonant body 302 is transmitted to the RX circuit 1032 in the circuit board 103 (as shown in FIG. 4A) through the second receiving connector 312RX for signal processing. In addition, the second sending connector 312TX shown in FIG. 10 may be coupled to the TX circuit 1031 in the circuit board 103 shown in FIG. 4A, so that the electrical signal from the circuit board 103 is transmitted to the second resonant body 302 for filtering, and then is transmitted to the antenna board 102 (as shown in FIG. 3B) through the first antenna connector 321 for sending. In this way, the second resonant body 302 may filter the electrical signal received by the antenna board 102, and may also filter an electrical signal to be sent by the antenna board 102. Therefore, the second resonant body 302 may be the foregoing duplexer.

In some embodiments of this application, still as shown in FIG. 10, the first resonant body 301 and the second resonant body 302 have a same shape and a same outline size. The first resonant body 301 and the second resonant body 302 have a same shape and a same outline size. In this way, the first resonant body 301 and the second resonant body 302 with a same shape may be prepared by using a same preparation process and a same cutting process, so that a preparation process of the resonant body can be simplified.

Based on this, a contour shape of the first resonant body may be a symmetric figure, and the first antenna connector 321 and the second antenna connector 322 are symmetrically disposed with respect to a symmetry axis O-O of the first resonant body 301. In this way, as shown in FIG. 11, a through hole 400 that is symmetrically provided with the second antenna connector 322 may be provided in the first resonant body 301, so that the second antenna connector 322 that passes through the through hole 400 and the first antenna connector 321 are symmetrically disposed with respect to the symmetry axis O-O (as shown in FIG. 10). In addition, the first receiving connector 311RX and the second receiving connector 312RX are symmetrically disposed with respect to the symmetry axis O-O of the first resonant body 301. The first sending connector 311TX and the second sending connector 312TX are symmetrically disposed with respect to the symmetry axis O-O of the first resonant body 301 (as shown in FIG. 10). Similarly, a through hole 400 that is symmetrically provided with the second receiving connector 312RX is provided in the second resonant body 302, so that the first receiving connector 311RX that pass through the through hole 400 and the second receiving connector 312RX are symmetrically disposed with respect to the symmetry axis O-O (as shown in FIG. 10). A through hole 400 that is symmetrically provided with the second sending connector 312TX is provided in the second resonant body 302, so that the first sending connector 311TX that pass through the through hole 400 and the second sending connector 312TX are symmetrically disposed with respect to the symmetry axis O-O (as shown in FIG. 10).

The foregoing is described by using an example in which the first antenna connector 321 shown in FIG. 10 and the first receiving connector 311RX (or the first sending connector 311TX) may be respectively located on two opposite sides of the first resonant body 301, and the second antenna connector 322 and the second receiving connector 312RX (or the second sending connector 312TX) may be respectively located on two opposite sides of the second resonant body 302.

In some other embodiments of this application, as shown in FIG. 12, when the filter 30 includes the first resonant body 301, the second resonant body 302, the first receiving connector 311RX, the first sending connector 311TX, the second receiving connector 312RX, the second sending connector 312TX, the first antenna connector 321, and the second antenna connector 322, the first antenna connector 321 and the first receiving connector 311RX (or the first sending connector 311TX) may be located on a same side of the first resonant body 301. In addition, the second antenna connector 322 and the second receiving connector 312RX (or the second sending connector 312TX) may be located on a same side of the second resonant body 302.

In this case, still as shown in FIG. 12, the first antenna connector 321 may penetrate the second resonant body 302, so that the second end (the end away from the second resonant body 302) of the first antenna connector 321 may be coupled to the antenna board 102 shown in FIG. 3A. A manner of disposing the first resonant body 301, the second resonant body 302, the first receiving connector 311RX, the first sending connector 311TX, the second receiving connector 312RX, the second sending connector 312TX, the first antenna connector 321, and the second antenna connector 322 is the same as that described above, and details are not described herein again.

Similarly, a manner in which the first antenna connector 321 penetrates the second resonant body 302 is similar to a manner in which the second antenna connector 322 penetrates the first resonant body 301 in FIG. 10, and details are not described herein again. In addition, to decouple the first antenna connector 321 from the second resonant body 302, it may be similarly learned that the first gap H1 (as shown in FIG. 5) may be provided between a part that penetrates the second resonant body 302 in the first antenna connector 321 and the second resonant body 302. A value of the first gap H1 is the same as that described above, and details are not described herein again.

The foregoing describes an example of a manner of disposing the first antenna connector 321 and the second antenna connector 322. For ease of description, the following uses an example in which the first antenna connector 321 and the second antenna connector 322 shown in FIG. 10 are disposed. Details are not described herein again.

It may be learned from the foregoing that, to adjust a resonance frequency of either of the first resonant body 301 and the second resonant body 302, at least one resonant cavity is disposed on the resonant body, and the resonant cavity may be formed by a blind hole provided in the resonant body and a part of a dielectric around the blind hole. The at least one resonant cavity may form a signal transceiver channel, to filter an electrical signal. The following uses an example in which the filter 30 is a band-pass filter to describe a manner of disposing signal transceiver channels on the first resonant body 301 and the second resonant body 302 that are independent of each other.

For example, as shown in FIG. 13, at least one first resonant cavity 601 and at least one second resonant cavity 602 are disposed on the first resonant body 301. The at least one first resonant cavity 601 may form a first signal receiving channel 711. The at least one second resonant cavity 602 may form a first signal sending channel 712, and a band-pass frequency of the first signal receiving channel 711 and a band-pass frequency of the first signal sending channel 712 are a first frequency F1. A quantity of first resonant cavities 601 in the first signal receiving channel 711, a spacing between two adjacent first resonant cavities 601, and a diameter and a depth of a blind hole that is included in the first resonant cavity 601 are not limited in embodiments of this application. In addition, a quantity of second resonant cavities 602 in the first signal sending channel 712, a spacing between two adjacent second resonant cavities 602, and a diameter and a depth of a blind hole that is included in the second resonant cavity 602 are not limited in embodiments of this application. In other words, a value of the first frequency F1 is not limited. FIG. 13 is merely an example of a manner of disposing the first resonant cavity 601 and the second resonant cavity 602.

Based on this, still as shown in FIG. 13, the first antenna connector 321 may be coupled to the first signal receiving channel 711 and the first signal sending channel 712, the first receiving connector 311RX is coupled to the first signal receiving channel 711, and the first sending connector 311TX is coupled to the first signal sending channel 712.

Based on this, two ends of the first signal receiving channel 711 may be respectively coupled to the first antenna connector 321 and the first receiving connector 311RX, and two ends of the first signal sending channel 712 may be respectively coupled to the first antenna connector 321 and the first sending connector 311TX. When the first antenna connector 321 is coupled to the antenna board 102 shown in FIG. 3A, and the first receiving connector 311RX and the first sending connector 311TX are coupled to the circuit board 103, an electrical signal received by the antenna board 102 (as shown in FIG. 3A) may be transmitted to the first signal receiving channel 711 for filtering, so that an electrical signal whose frequency is the first frequency F1 may be transmitted to the circuit board 103 (as shown in FIG. 3A) through the first receiving connector 311RX for signal processing. In addition, an electrical signal on the circuit board 103 (as shown in FIG. 3A) may be transmitted to the first signal sending channel 712 through the first sending connector 311TX for filtering, so that the electrical signal whose frequency is the first frequency F1 may be transmitted to the antenna board 102 (as shown in FIG. 3A) through the first antenna connector 321 and sent. In this way, the first resonant body 301 may have a signal transceiver channel (including the first signal receiving channel 711 and the first signal sending channel 712) corresponding to a single band-pass frequency, namely, the first frequency F1.

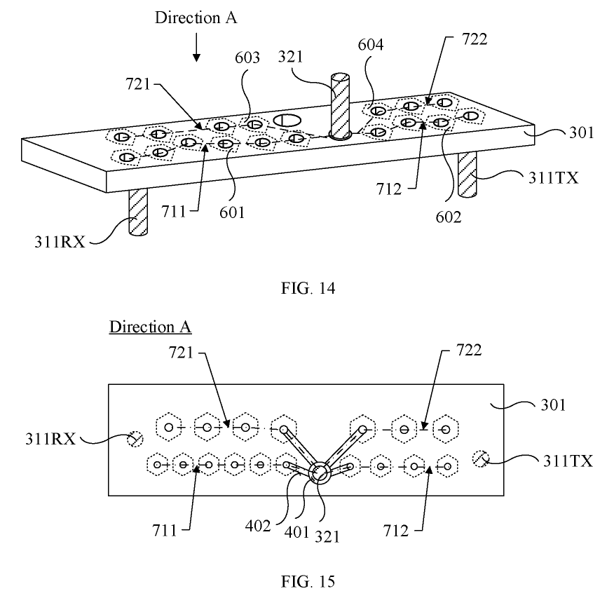

In some other embodiments of this application, the first resonant body 301 may have signal transceiver channels that respectively correspond to two band-pass frequencies. Specifically, as shown in FIG. 14, at least one third resonant cavity 603 and at least one fourth resonant cavity 604 may be disposed on the first resonant body 301, the at least one third resonant cavity 603 forms a second signal receiving channel 721, the at least one fourth resonant cavity 604 forms a second signal sending channel 722, and a band-pass frequency of the second signal receiving channel 721 and a band-pass frequency of the second signal sending channel 722 are a second frequency F2.

The first antenna connector 321 is coupled to the second signal receiving channel 721 and the second signal sending channel 722, the first receiving connector 311RX is coupled to the second signal receiving channel 721, and the first sending connector 311TX is coupled to the second signal sending channel 722. Similarly, two ends of the second signal receiving channel 721 may be respectively coupled to the first antenna connector 321 and the first receiving connector 311RX, and two ends of the second signal sending channel 722 may be respectively coupled to the first antenna connector 321 and the first sending connector 311TX. When the first antenna connector 321 is coupled to the antenna board 102 shown in FIG. 3A, and the first receiving connector 311RX and the first sending connector 311TX are coupled to the circuit board 103, an electrical signal received by the antenna board 102 (as shown in FIG. 3A) may be transmitted to the second signal receiving channel 721 for filtering, so that an electrical signal whose frequency is the second frequency F2 may be transmitted to the circuit board 103 (as shown in FIG. 3A) through the first receiving connector 311RX for signal processing. In addition, an electrical signal on the circuit board 103 (as shown in FIG. 3A) may be transmitted to the second signal sending channel 722 through the first sending connector 311TX for filtering, so that an electrical signal whose frequency is the second frequency F2 may be transmitted to the antenna board 102 (as shown in FIG. 3A) through the first antenna connector 321 and sent.

In this way, the first resonant body 301 may have a signal transceiver channel (including the first signal receiving channel 711 and the first signal sending channel 712) corresponding to the first frequency F1, and a signal transceiver channel (including the second signal receiving channel 721 and the second signal sending channel 722) corresponding to the second frequency F2. The first frequency F1 and the second frequency F2 may be the same, or the first frequency F1 and the second frequency F2 may be different. This is not limited in this application.

In some embodiments of this application, when the first frequency F1 is different from the second frequency F2, the first antenna connector 321 may be coupled to both the first signal receiving channel 711 and the first signal sending channel 712, and the second signal receiving channel 721 and the second signal sending channel 722. For example, as shown in FIG. 15 (a top view obtained in a direction A in FIG. 14), a first blind hole 401 is provided in the first resonant body 301, and the first blind hole 401 may be coupled to the first signal receiving channel 711, the first signal sending channel 712, the second signal receiving channel 721, and the second signal sending channel 722. In this case, the first antenna connector 321 may be disposed in the first blind hole 401, so that the first antenna connector 321 may be coupled to the first signal receiving channel 711 and the first signal sending channel 712, and may be coupled to the second signal receiving channel 721 and the second signal sending channel 722 through the first blind hole 401.

Based on this, still as shown in FIG. 15, to couple an electrical signal received by the first antenna connector 321 to the first resonant body 301 more easily, or couple an electrical signal of the first resonant body 301 to the first antenna connector 321 more easily, in some embodiments of this application, a coupling cavity 402 may be disposed on the first resonant body 301. One end of the coupling cavity 402 may be connected to the first blind hole 401. In addition, another end of the coupling cavity 402 may be further connected to a blind hole of a resonant cavity that is closest to the first blind hole 401 and that is in a signal transceiver channel coupled to the first blind hole 401, so that the electrical signal is more easily transmitted between the first blind hole 401 and the signal transceiver channel.

In addition, still as shown in FIG. 15, when the first antenna connector 321 receives an electrical signal of the first frequency F1 and an electrical signal of the second frequency F2 at the same time, and the first frequency F1 is different from the second frequency F2, the first antenna connector 321 may transmit the electrical signal of the first frequency F1 to the first signal receiving channel 711, and transmit the electrical signal of the second frequency F2 to the second signal receiving channel 721. In this way, frequency division is performed on the received electrical signal of the first frequency F1 and the received electrical signal of the second frequency F2 at an end that is of the first antenna connector 321 and that faces the first resonant body 301, and are respectively coupled to different signal receiving channels, thereby reducing mutual crosstalk between the electrical signal of the first frequency F1 and the electrical signal of the second frequency F2.

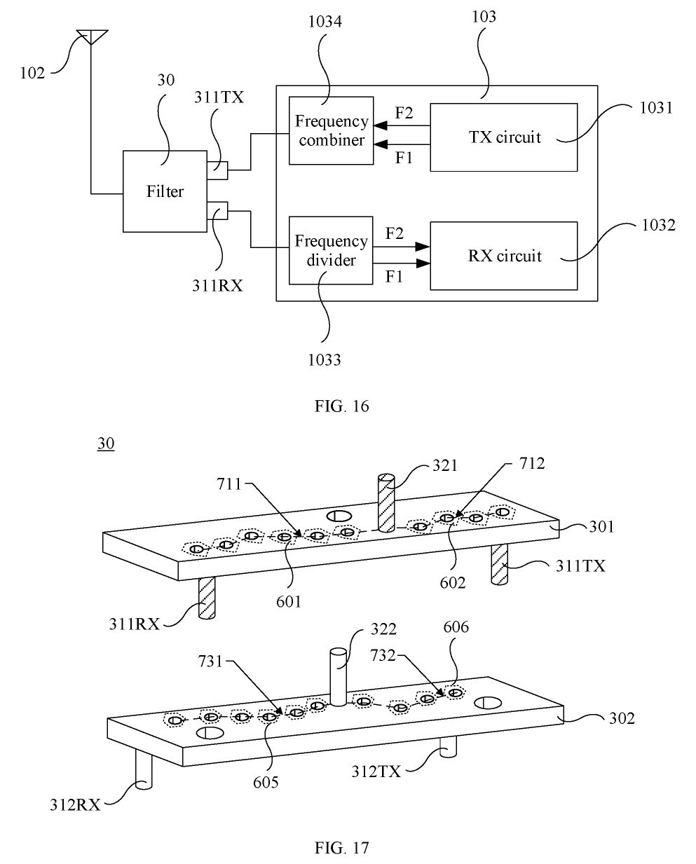

Based on this, the first receiving connector 311RX is coupled to both the first signal receiving channel 711 and the second signal receiving channel 721. The antenna apparatus may further include a frequency divider 1033, to enable the RX circuit 1032 on the circuit board 103 shown in FIG. 16 to separately process the electrical signal of the first frequency F1 and the electrical signal of the second frequency F2 that are received by the first receiving connector 311RX. The frequency divider 1033 may be disposed on the circuit board, and the frequency divider 1033 may be coupled to the circuit board 103 and the first receiving connector 311RX. In this way, the electrical signal of the first frequency F1 and the electrical signal of the second frequency F2 that are received by the first receiving connector 311RX may be output to the RX circuit 1032 separately under frequency division of the frequency divider 1033, and the electrical signal of the first frequency F1 and the electrical signal of the second frequency F2 are separately output.

In addition, still as shown in FIG. 16, when the TX circuit 1031 on the circuit board 103 outputs the electrical signal of the first frequency F1 and the electrical signal of the second frequency F2, the antenna apparatus may further include a frequency combiner 1034. The frequency combiner 1034 may be disposed on the circuit board 103, and the frequency combiner 1034 may be coupled to the circuit board 103 and the first sending connector 311TX. In this way, the electrical signal of the first frequency F1 and the electrical signal of the second frequency F2 that are output by the TX circuit 1031 may be transmitted to the first sending connector 311TX after frequency combining is performed by the frequency combiner 1034. The first sending connector 311TX may transmit the electrical signal of the first frequency F1 to the first antenna connector 321 through the first signal sending channel 712 shown in FIG. 15. In addition, the first sending connector 311TX may further transmit the electrical signal of the second frequency F2 to the first antenna connector 321 through the second signal sending channel 722 shown in FIG. 15. Therefore, the first antenna connector 321 may send the electrical signal of the first frequency F1 and the electrical signal of the second frequency F2 through the antenna board 102 shown in FIG. 16, to increase signal transceiver channels.

The foregoing describes an example of a manner of disposing the signal transceiver channel of the first resonant body 301. The following uses an example to describe a manner of disposing the signal transceiver channel of the second resonant body 302 shown in FIG. 17.

In some embodiments of this application, similar to the manner of disposing the signal transceiver channel of the first resonant body 301 shown in FIG. 13, as shown in FIG. 17, at least one fifth resonant cavity 605 and at least one sixth resonant cavity 606 may be disposed on the second resonant body 302. The at least one fifth resonant cavity 605 may form a third signal receiving channel 731, the at least one sixth resonant cavity 606 may form a third signal sending channel 732, and a band-pass frequency of the third signal receiving channel 731 and a band-pass frequency of the third signal sending channel 732 are a third frequency F3.

A quantity and sizes of fifth resonant cavities 605 in the third signal receiving channel 731, and a quantity and sizes of sixth resonant cavities 606 in the third signal sending channel 732 are not limited in embodiments of this application, in other words, a value of the third frequency F3 is not limited. FIG. 17 is merely an example of a manner of disposing the fifth resonant cavity 605 and the sixth resonant cavity 606. In addition, the third frequency F3 may be the same as or different from the first frequency F1 and the second frequency F2.

Based on this, still as shown in FIG. 17, the second antenna connector 322 may be coupled to the third signal receiving channel 731 and the third signal sending channel 732, the second receiving connector 312RX is coupled to the third signal receiving channel 731, and the second sending connector 312TX is coupled to the third signal sending channel 732.

Similarly, two ends of the third signal receiving channel 731 may be respectively coupled to the second antenna connector 322 and the second receiving connector 312RX, and two ends of the third signal sending channel 732 may be respectively coupled to the second antenna connector 322 and the second sending connector 312TX. When the second antenna connector 322 is coupled to the antenna board 102 shown in FIG. 3A, and the second receiving connector 312RX and the second sending connector 312TX are coupled to the circuit board 103, an electrical signal received by the antenna board 102 (as shown in FIG. 3A) may be transmitted to the third signal receiving channel 731 for filtering, so that an electrical signal whose frequency is the third frequency F3 may be transmitted to the circuit board 103 (as shown in FIG. 3A) through the second receiving connector 321RX for signal processing. In addition, an electrical signal on the circuit board 103 (as shown in FIG. 3A) may be transmitted to the third signal sending channel 732 through the second sending connector 321TX for filtering, so that the electrical signal whose frequency is the third frequency F3 may be transmitted to the antenna board 102 (as shown in FIG. 3A) through the second antenna connector 322 and sent. In this way, the second resonant body 302 may have a signal transceiver channel (including the third signal receiving channel 731 and the third signal sending channel 732) corresponding to a single band-pass frequency, namely, the third frequency F3.

Based on this, when the first resonant body 301 has one signal transceiver channel (including the first signal receiving channel 711 and the first signal sending channel 712), a band-pass frequency of the signal transceiver channel is the first frequency F1, and the first frequency F1 is different from the third frequency F3, because the first resonant body 301 and the second resonant body 302 are in a decoupled state, crosstalk between an electrical signal (whose band-pass frequency is the first frequency F1) that is filtered through the first resonant body 301 and an electrical signal (whose band-pass frequency is the third frequency F3) that is filtered through the second resonant body 302 can be reduced.

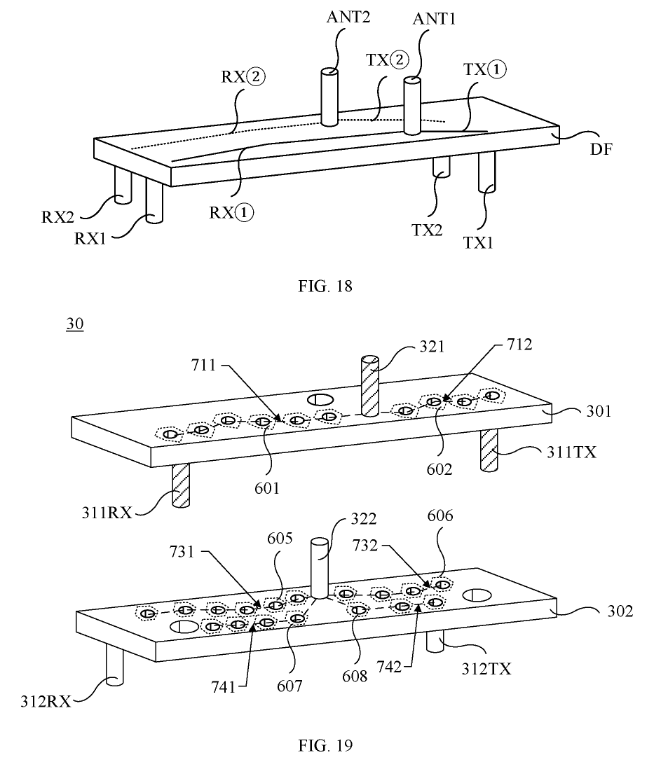

Based on this, in a related technology, as shown in FIG. 18, the DF has two antenna connectors, which are respectively ANT1 and ANT2, and are configured to receive electrical signals of different frequencies. The ANT1 is coupled to the receiving connector RX1 through a receiving channel RX①, and the ANT1 is coupled to the sending connector TX1 through a sending channel TX①. In addition, the ANT1 is coupled to the receiving connector RX2 through a receiving channel RX②, and the ANT1 is coupled to the sending connector TX2 through a sending channel TX②. The receiving channel RX① and the sending channel TX① form a first signal channel, and the receiving channel RX② and the sending channel TX② form a second signal channel. Signals transmitted on the first signal channel and the second signal channel have different frequencies. In this case, when a size of a resonant cavity in the first signal channel is adjusted, a resonance frequency of the second signal channel is affected. Similarly, when a size of a resonant cavity in the second signal channel is adjusted, a resonance frequency of the first signal channel is affected accordingly.

In comparison with the related technology, in the filter 30 shown in FIG. 17 provided in this embodiment of this application, it can be learned from the foregoing that the first resonant body 301 and the second resonant body 302 are in a decoupled state. Therefore, when a structure of a signal transceiver channel (including the first signal receiving channel 711 and the first signal sending channel 712) used for filtering on the first resonant body 301 is adjusted, a structure of a signal transceiver channel (including the third signal receiving channel 731 and the third signal sending channel 732) used for filtering on the second resonant body 302 is not affected. Similarly, when a structure of a signal transceiver channel (including the third signal receiving channel 731 and the third signal sending channel 732) used for filtering on the second resonant body 302 is adjusted, a structure of a signal transceiver channel (including the first signal receiving channel 711 and the first signal sending channel 712) used for filtering on the first resonant body 301 is not affected.

FIG. 17 is described by using an example in which the second resonant body 302 has one signal transceiver channel (including the third signal receiving channel 731 and the third signal sending channel 732). In some other embodiments of this application, the second resonant body 302 may have signal transceiver channels that respectively correspond to two band-pass frequencies. Specifically, as shown in FIG. 19, in addition to the at least one fifth resonant cavity 605 configured to form the third signal receiving channel 731 and the at least one sixth resonant cavity 606 configured to form the third signal sending channel 732 that are disposed on the second resonant body 302, at least one seventh resonant cavity 607 and at least one eighth resonant cavity 608 are further disposed on the second resonant body 302. The at least one seventh resonant cavity 607 forms a fourth signal receiving channel 741, the at least one eighth resonant cavity 608 forms a fourth signal sending channel 742, and a band-pass frequency of the fourth signal receiving channel 741 and a band-pass frequency of the fourth signal sending channel 742 are a fourth frequency F4.

In addition, the second antenna connector 322 may be coupled to the third signal receiving channel 731 and the third signal sending channel 732, and the second antenna connector 322 is further coupled to the fourth signal receiving channel 741 and the fourth signal sending channel 742. The second receiving connector 312RX is coupled to the third signal receiving channel 731 and the fourth signal receiving channel 741, and the second sending connector 312TX is coupled to the third signal sending channel 732 and the fourth signal sending channel 742.

When the second antenna connector 322 is coupled to the antenna board 102 shown in FIG. 3A, and the second receiving connector 321RX and the second sending connector 312TX are coupled to the circuit board 103, an electrical signal received by the antenna board 102 (as shown in FIG. 3A) may be transmitted to the fourth signal receiving channel 741 for filtering, so that an electrical signal whose frequency is the fourth frequency F4 may be transmitted to the circuit board 103 (as shown in FIG. 3A) through the second receiving connector 321RX for signal processing. In addition, an electrical signal on the circuit board 103 (as shown in FIG. 3A) may be transmitted to the fourth signal sending channel 742 through the second sending connector 312TX for filtering, so that the electrical signal whose frequency is the fourth frequency F4 may be transmitted to the antenna board 102 (as shown in FIG. 3A) through the second antenna connector 322 and sent.

In this way, the second resonant body 302 may have a signal transceiver channel (including the third signal receiving channel 731 and the third signal sending channel 732) corresponding to the third frequency F3, and a signal transceiver channel (including the fourth signal receiving channel 741 and the fourth signal sending channel 742) corresponding to the fourth frequency F4. The fourth frequency F4 may be the same as the third frequency F3, or the fourth frequency F4 may be different from the third frequency F3. This is not limited in this application. In addition, the fourth frequency F4 may be the same as or different from either of the first frequency F1 and the second frequency F2. This is not limited in this application.

Similarly, in some embodiments of this application, when the fourth frequency F4 is different from the third frequency F3, a second blind hole (not shown in the figure) may also be provided in the second resonant body 302, and the second blind hole may be coupled to the third signal receiving channel 731, the third signal sending channel 732, the fourth signal receiving channel 741, and the fourth signal sending channel 742. In this case, the second antenna connector 322 may be disposed in the second blind hole, so that the second antenna connector 322 may be coupled to the third signal receiving channel 731 and the third signal sending channel 732, and may be coupled to the fourth signal receiving channel 741 and the fourth signal sending channel 742 through the second blind hole.

In this way, when the second antenna connector 322 receives an electrical signal of the third frequency F3 and an electrical signal of the third frequency F4 at the same time, the second antenna connector 322 may transmit the electrical signal of the third frequency F3 to the third signal receiving channel 731, and transmit the electrical signal of the fourth frequency F4 to the fourth signal receiving channel 741. In this way, frequency division is performed on the received electrical signal of the third frequency F3 and the received electrical signal of the third frequency F4 at an end that is of the second antenna connector 322 and that faces the second resonant body 302, and are respectively coupled to different signal receiving channels, thereby reducing mutual crosstalk between the electrical signal of the third frequency F3 and the electrical signal of the fourth frequency F4.

It can be learned from the foregoing that, FIG. 17 and FIG. 19 are described by using an example in which the first resonant body 301 has one signal transceiver channel (including the first signal receiving channel 711 and the first signal sending channel 712). In some other embodiments of this application, the first resonant body 301 may further include two signal transceiver channels shown in FIG. 14, which are respectively a signal transceiver channel including the first signal receiving channel 711 and the first signal sending channel 712, and a signal transceiver channel including the second signal receiving channel 721 and the second signal sending channel 722.

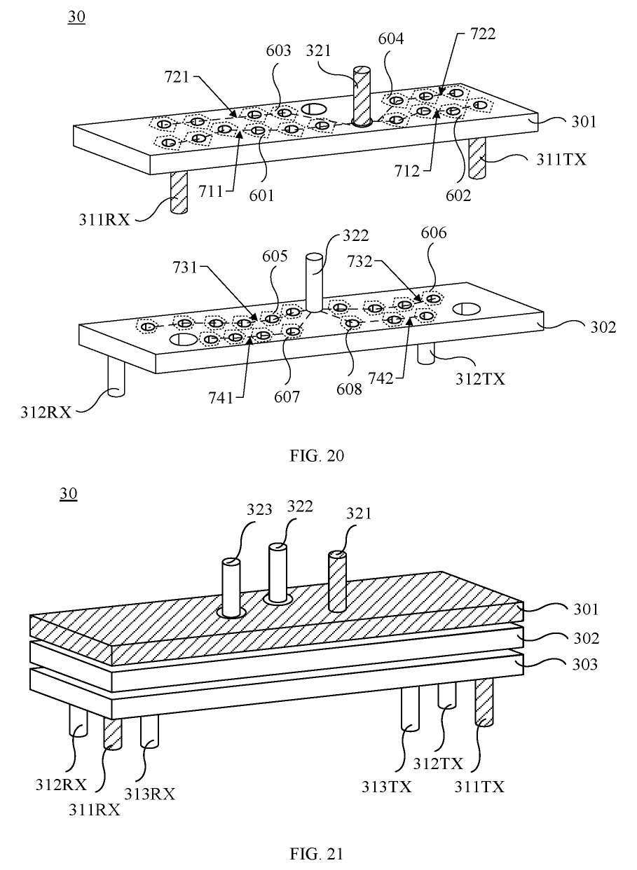

Based on this, in some embodiments of this application, as shown in FIG. 20, the first resonant body 301 may include two signal transceiver channels, which are respectively a signal transceiver channel (whose band-pass frequency is the first frequency F1) including the first signal receiving channel 711 and the first signal sending channel 712, and a signal transceiver channel (whose band-pass frequency is the second frequency F2) including the second signal receiving channel 721 and the second signal sending channel 722. The second resonant body 302 may include two signal transceiver channels, which are respectively a signal transceiver channel (whose band-pass frequency is the third frequency F3) including the third signal receiving channel 731 and the third signal sending channel 732, and a signal transceiver channel (whose band-pass frequency is the fourth frequency F4) including the fourth signal receiving channel 741 and the fourth signal sending channel 742.

The first frequency F1 and the third frequency F3 may be the same, and the second frequency F2 and the fourth frequency F4 may be the same. The first frequency F1 may be different from the second frequency F2. In this case, either of the first resonant body 301 and the second resonant body 302 may have two signal transceiver channels of different frequencies.

Based on this, because the first frequency F1 is the same as the third frequency F3, the structure of the first signal receiving channel 711 may be the same as that of the third signal receiving channel 731, and the structure of the first signal sending channel 712 may be the same as that of the third signal sending channel 732. Specifically, parameters such as a quantity and sizes of first resonant cavities 601 in the first signal receiving channel 711, and a spacing between two adjacent first resonant cavities 601 are respectively the same as parameters such as a quantity and sizes of fifth resonant cavities 605 in the third signal receiving channel 731, and a spacing between two adjacent fifth resonant cavities 605. Parameters such as a quantity and sizes of second resonant cavities 602 in the first signal sending channel 712, and a spacing between two adjacent second resonant cavities 602 are respectively the same as parameters such as a quantity and sizes of sixth resonant cavities 606 in the third signal sending channel 732, and a spacing between two adjacent sixth resonant cavities 606.

Similarly, because the second frequency F2 is the same as the fourth frequency F4, the structure of the second signal receiving channel 721 may be the same as that of the fourth signal receiving channel 741, and the structure of the second signal sending channel 722 may be the same as that of the fourth signal sending channel 742. A manner of disposing resonant cavities in signal transceiver channels with the same structure is the same as that described above, and details are not described herein again.

The foregoing uses an example in which the filter 30 includes two layers of stacked resonant bodies, namely, the first resonant body 301 and the second resonant body 302, for description. In some other embodiments of this application, as shown in FIG. 21, the filter 30 may further include three layers of resonant bodies, which are respectively the first resonant body 301, the second resonant body 302, and a third resonant body 303. A manner of disposing the first antenna connector 321, the first receiving connector 311RX, and the first sending connector 311TX on the first resonant body 301, and the second antenna connector 322, the second receiving connector 312RX, and the second sending connector 312TX on the second resonant body 302 is the same as that described above. Details are not described herein again.

In addition, still as shown in FIG. 21, the third resonant body 303 is stacked on a side that is of the second resonant body 302 and that is away from the first resonant body 301, and the third resonant body 303 is decoupled from at least one of the first resonant body 301 and the second resonant body 302. The first connector (including the first receiving connector 311RX and the first sending connector 311TX) penetrates the second resonant body 302 and the third resonant body 303, and the first receiving connector 311RX and the first sending connector 311TX are decoupled from the second resonant body 302 and the third resonant body 303. In addition, second ends (namely, ends away from the first resonant body 301) of the first receiving connector 311RX and the first sending connector 311TX extend out of the third resonant body 303.

Still as shown in FIG. 21, the second connector (the second receiving connector 312RX and the second sending connector 312TX) penetrates the third resonant body 303, and the second receiving connector 312RX and the second sending connector 312TX are decoupled from the third resonant body 303. Second ends (namely, ends away from the second resonant body 302) of the second receiving connector 312RX and the second sending connector 312TX extend out of the third resonant body 303.

Based on this, the filter 30 may further include at least one third connector (for example, a third receiving connector 313RX and a third sending connector 313TX). First ends (namely, ends close to the third resonant body 303) of the third receiving connector 313RX and the third sending connector 313TX are coupled to the third resonant body 303. The third receiving connector 313RX, the third sending connector 313TX and the second connector (the second receiving connector 312RX or the second sending connector 312TX) are disposed on a same side of the first resonant body 301. In addition, the filter 30 may further include a third antenna connector 323. One end that is of the third antenna connector 323 and that faces the third resonant body 303 is coupled to the third resonant body 303. One end that is of the third antenna connector 323 and that is away from the third resonant body 303 penetrates the second resonant body 302 and the first resonant body 301, and extends out of the first resonant body 301. A manner of disposing the signal transceiver channel on the third resonant body 303, and a manner of coupling the third antenna connector 323, the third receiving connector 313RX, and the third sending connector 313TX to the signal transceiver channel are the same as those described above, and details are not described herein again.

Similarly, in this way, because any two of the first resonant body 301, the second resonant body 302, and the third resonant body 303 are decoupled from each other, any two of the first resonant body 301, the second resonant body 302, and the third resonant body 303 are independent of each other, and an electrical signal transmitted on the first resonant body 301 does not affect an electrical signal transmitted on the second resonant body 302 and an electrical signal transmitted on the third resonant body 303. In this case, the first resonant body 301, the second resonant body 302, and the third resonant body 303 may have independent signal transceiver channels, so that a quantity of signal transceiver channels can be effectively increased. In addition, a plurality of resonant bodies are stacked. Therefore, when it is ensured that a quantity of channels can be increased, a board layout area occupied by the filter 30 on a surface of the circuit board 103 is reduced, and a problem that the antenna apparatus and the communication device having the filter 30 have a large size is alleviated.

The foregoing description is provided by using an example in which the filter 30 may further include three layers of resonant bodies. The filter 30 may further include more than three resonant bodies that are stacked. A manner of stacking the resonant bodies, signal transceiver channels on the resonant bodies, and a manner of disposing the connectors are the same as those described above, and details are not described herein again.

The foregoing descriptions are merely specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

What is claimed is:

1. A filter, comprising:
a first resonant body;
a second resonant body, stacked with the first resonant body, wherein the second resonant body is decoupled from the first resonant body;
at least one first connector that penetrates the second resonant body and is decoupled from the second resonant body, wherein a first end of the first connector is coupled to the first resonant body, and a second end of the first connector extends out of the second resonant body; and
at least one second connector, wherein a first end of the second connector is coupled to the second resonant body, and the second connector and the first connector are disposed on a same side of the first resonant body.

2. The filter according to claim 1, wherein
the at least one first connector comprises:
a first receiving connector; and
a first sending connector, wherein the first sending connector and the first receiving connector are located on a same side of the first resonant body; and
the at least one second connector comprises:
a second receiving connector, wherein the second receiving connector and the first receiving connector are disposed on a same side of the first resonant body; and
a second sending connector, wherein the second sending connector and the first sending connector are disposed on a same side of the first resonant body.

3. The filter according to claim 2, wherein the filter further comprises:
a first antenna connector, wherein a first end of the first antenna connector is coupled to the first resonant body, and the first antenna connector and the first receiving connector are respectively located on two opposite sides of the first resonant body; and
a second antenna connector that penetrates the first resonant body and is decoupled from the first resonant body, wherein a first end of the second antenna connector is coupled to the second resonant body, and the second antenna connector and the second receiving connector are respectively located on two opposite sides of the second resonant body.

4. The filter according to claim 2, wherein the filter further comprises:
a first antenna connector that penetrates the second resonant body and is decoupled from the second resonant body, wherein a first end of the first antenna connector is coupled to the first resonant body, and the first antenna connector and the first receiving connector are located on a same side of the first resonant body; and
a second antenna connector, wherein a first end of the second antenna connector is coupled to the second resonant body, and the second antenna connector and the second receiving connector are located on a same side of the second resonant body.

5. The filter according to claim 3, wherein
at least one first resonant cavity and at least one second resonant cavity are disposed on the first resonant body, the at least one first resonant cavity forms a first signal receiving channel, the at least one second resonant cavity forms a first signal sending channel, and a band-pass frequency of the first signal receiving channel and a band-pass frequency of the first signal sending channel are a first frequency; and
the first antenna connector is coupled to the first signal receiving channel and the first signal sending channel, the first receiving connector is coupled to the first signal receiving channel, and the first sending connector is coupled to the first signal sending channel.

6. The filter according to claim 5, wherein
at least one third resonant cavity and at least one fourth resonant cavity are disposed on the first resonant body, the at least one third resonant cavity forms a second signal receiving channel, the at least one fourth resonant cavity forms a second signal sending channel, and a band-pass frequency of the second signal receiving channel and a band-pass frequency of the second signal sending channel are a second frequency; and
the first antenna connector is coupled to the second signal receiving channel and the second signal sending channel, the first receiving connector is coupled to the second signal receiving channel, and the first sending connector is coupled to the second signal sending channel.

7. The filter according to claim 6, wherein
a first blind hole is provided in the first resonant body, the first blind hole is coupled to the first signal receiving channel, the first signal sending channel, the second signal receiving channel, and the second signal sending channel, and the first antenna connector is disposed in the first blind hole.

8. The filter according to claim 5, wherein
at least one fifth resonant cavity and at least one sixth resonant cavity are disposed on the second resonant body, the at least one fifth resonant cavity forms a third signal receiving channel, the at least one sixth resonant cavity forms a third signal sending channel, and a band-pass frequency of the third signal receiving channel and a band-pass frequency of the third signal sending channel are a third frequency; and
the second antenna connector is coupled to the third signal receiving channel and the third signal sending channel, the second receiving connector is coupled to the third signal receiving channel, and the second sending connector is coupled to the third signal sending channel.

9. The filter according to claim 6, wherein
at least one fifth resonant cavity and at least one sixth resonant cavity are disposed on the second resonant body, the at least one fifth resonant cavity forms a third signal receiving channel, the at least one sixth resonant cavity forms a third signal sending channel, and a band-pass frequency of the third signal receiving channel and a band-pass frequency of the third signal sending channel are a third frequency;
at least one seventh resonant cavity and at least one eighth resonant cavity are disposed on the second resonant body, the at least one seventh resonant cavity forms a fourth signal receiving channel, the at least one eighth resonant cavity forms a fourth signal sending channel, and a band-pass frequency of the fourth signal receiving channel and a band-pass frequency of the fourth signal sending channel are a fourth frequency; and
the second antenna connector is coupled to the third signal receiving channel, the third signal sending channel, the fourth signal receiving channel, and the fourth signal sending channel; and the second receiving connector is coupled to the third signal receiving channel and the fourth signal receiving channel, and the second sending connector is coupled to the third signal sending channel and the fourth signal sending channel.

10. The filter according to claim 1, wherein
a contour shape of the first resonant body is a symmetric figure;
the first antenna connector and the second antenna connector are symmetrically disposed with respect to a symmetry axis of the first resonant body;
the first receiving connector and the second receiving connector are symmetrically disposed with respect to the symmetry axis of the first resonant body; and
the first sending connector and the second sending connector are symmetrically disposed with respect to the symmetry axis of the first resonant body.

11. The filter according to claim 9, wherein
the first frequency is the same as the third frequency, and the second frequency is the same as the fourth frequency.

12. The filter according to claim 1, wherein the filter further comprises:
a third resonant body, stacked on a side that is of the second resonant body and that is away from the first resonant body, wherein the third resonant body is decoupled from the first resonant body and the second resonant body; the first connector penetrates the third resonant body and is decoupled from the third resonant body, and the second end of the first connector extends out of the third resonant body; and the second connector penetrates the third resonant body and is decoupled from the third resonant body, and a second end of the second connector extends out of the third resonant body; and
at least one third connector, wherein a first end of the third connector is coupled to the third resonant body, and the third connector and the second connector are disposed on a same side of the first resonant body.

13. The filter according to claim 1, wherein
a first gap H1 is provided between the second resonant body and a part that is of the first connector and that penetrates the second resonant body.

14. The filter according to claim 13, wherein 0 < H1 ≤ 3 mm.

15. The filter according to claim 1, wherein a second gap H2 is provided between the first resonant body and the second resonant body.

16. The filter according to claim 1, wherein the filter further comprises:
an insulation adhesive layer, disposed between the first resonant body and the second resonant body, wherein the insulation adhesive layer is adhered to the first resonant body and the second resonant body.

17. An antenna apparatus, comprising:
a circuit board; and
a filter, comprising:
a first resonant body;
a second resonant body, stacked with the first resonant body, wherein the second resonant body is decoupled from the first resonant body;
at least one first connector that penetrates the second resonant body and is decoupled from the second resonant body, wherein a first end of the first connector is coupled to the first resonant body, and a second end of the first connector extends out of the second resonant body; and
at least one second connector, wherein a first end of the second connector is coupled to the second resonant body, and the second connector and the first connector are disposed on a same side of the first resonant body.

18. The antenna apparatus according to claim 17, wherein
the at least one first connector comprises the first receiving connector and the first sending connector, the filter further comprises the first antenna connector, and the first antenna connector is coupled to the first resonant body;
the first signal receiving channel and the first signal sending channel are disposed on the first resonant body, and the band-pass frequency of the first signal receiving channel and the band-pass frequency of the first signal sending channel are the first frequency; the second signal receiving channel and the second signal sending channel are disposed on the first resonant body, and the band-pass frequency of the second signal receiving channel and the band-pass frequency of the second signal sending channel are the second frequency; the first antenna connector is coupled to the first signal receiving channel, the first signal sending channel, the second signal receiving channel, and the second signal sending channel; and the first receiving connector is coupled to the first signal receiving channel and the second signal receiving channel, and the first sending connector is coupled to the first signal sending channel and the second signal sending channel; and
the antenna apparatus further comprises:
a frequency divider, disposed on the circuit board, wherein the frequency divider is coupled to the circuit board and the first receiving connector; and
a frequency combiner, disposed on the circuit board, wherein the frequency combiner is coupled to the circuit board and the first sending connector.

19. A communication device, comprising:
a mounting bracket and a antenna apparatus which comprises:
a circuit board; and
a filter which comprise:
a first resonant body;
a second resonant body, stacked with the first resonant body, wherein the second resonant body is decoupled from the first resonant body;
at least one first connector that penetrates the second resonant body and is decoupled from the second resonant body, wherein a first end of the first connector is coupled to the first resonant body, and a second end of the first connector extends out of the second resonant body; and
at least one second connector, wherein a first end of the second connector is coupled to the second resonant body, and the second connector and the first connector are disposed on a same side of the first resonant body, wherein the antenna apparatus is disposed on the mounting bracket.
